(19) United States
(12) Patent Application Publication
(10) Pub. No.: US 2011/0065007 A1
(43) Pub. Date: Mar. 17, 2011

(54) ELECTRODE ACTIVE MATERIAL LAYER, ALL SOLID STATE BATTERY, MANUFACTURING METHOD FOR ELECTRODE ACTIVE MATERIAL LAYER, AND MANUFACTURING METHOD FOR ALL SOLID STATE BATTERY

(75) Inventors: Masato KAMIYA, Susono-shi (JP); Yukiyoshi Ueno, Gotenba-shi (JP); Shigenori Hama, Susono-shi (JP); Yasushi Tsuchida, Susono-shi (JP)

(73) Assignee: TOYOTA JIDOSHA KABUSHIKI KAISHA, Toyota-shi (JP)

(21) Appl. No.: 12/877,382

(22) Filed: Sep. 8, 2010

(30) Foreign Application Priority Data
Sep. 11, 2009 (JP) 2009-210522

(51) Int. Cl. H01M 10/0562; B29C 43/02

(52) U.S. Cl. 429/322; 264/104; 429/304

(57) ABSTRACT

An electrode active material layer includes an electrode active material and a sulfide solid state electrolyte material which is fused to a surface of the electrode active material and is substantially free of bridging sulfur.

### INCORPORATION BY REFERENCE

The disclosure of Japanese Patent Application No. 2009-210522, filed on Sep. 11, 2009 including the specification, drawings and abstract, is incorporated herein by reference in its entirety.

### BACKGROUND OF THE INVENTION

1. Field of the Invention

The invention relates to an electrode active material layer that is capable of suppressing generation of a high-resistance layer caused by a reaction between an electrode active material and a sulfide solid state electrolyte material and therefore has low interface resistance.

2. Description of the Related Art

With the rapid popularization of information-related devices, communication devices, and so on such as personal computers, video cameras, and portable telephones in recent years, the importance of developing superior batteries (lithium batteries, for example) that can be used as power supplies for these devices has grown. Moreover, in fields other than information-related devices and communication-related devices, for example in the automobile industry, the development of lithium batteries and the like that can be used in electric automobiles and hybrid automobiles is progressing.

An organic electrolyte employing a combustible organic solvent is used in a commercially available lithium battery, and therefore improvements are required in the manner of attaching safety devices for suppressing temperature increases during short-circuits and structures/material surfaces for preventing short-circuits. In an all solid state battery in which a liquid electrolyte is replaced by a solid state electrolyte, on the other hand, a combustible organic solvent is not used in the battery, and therefore the safety device can be simplified, leading to a reduction in manufacturing cost and an improvement in productivity.

As conventional related art in the field of all solid state batteries, a sulfide solid state electrolyte material having high lithium (Li) ion conductivity is used on an electrode active material layer. For example, Japanese Patent Application Publication No. 2008-270137 (JP-A-2008-270137) discloses a composite material layer formed by pressure molding a mixture of sulfide glass (a sulfide solid state electrolyte material) and an active material. Further, JP-A-2008-270137 describes a pressure-molded composite material layer that is baked at a temperature no lower than a glass transition point. In this technique, which focuses on the favorable pressure molding characteristic of sulfide glass, a composite material layer containing sulfide glass is pressure-molded and then baked to obtain a composite material layer exhibiting high Li ion conductivity.

Further, Japanese Patent Application Publication No. 2008-103244 (JP-A-2008-103244) discloses a method of manufacturing a positive electrode layer for a secondary battery in which a mixture of a lithium metal oxide (an electrode active material) and lithium-phosphorus sulfide-based glass (a sulfide solid state electrolyte material) is molded and then subjected to heat treatment. In this technique, heating processing is performed after molding, and therefore improvements in battery characteristics such as a rate characteristic and a cycle characteristic are obtained.

Furthermore, Japanese Patent Application Publication No. 8-138724 (JP-A-8-138724) discloses a method of manufacturing an all solid state lithium secondary battery in which a solid state electrolyte layer obtained by pressure molding a solid state electrolyte powder is sandwiched between a positive electrode, which is constituted by a mixture of a positive electrode active material powder and a solid state electrolyte powder, and a negative electrode, which is constituted by a negative active material powder and a solid state electrolyte powder, whereupon pressure molding is performed thereon at a temperature no lower than a softening point and no higher than a glass transition point of the solid state electrolyte. With this technique, the solid state electrolyte material and the active material are joined in a state of surface contact rather than point contact, and therefore low resistance is achieved.

Among sulfide solid state electrolyte materials, a sulfide solid state electrolyte material containing bridging sulfur is advantaged in that it exhibits high ion conductivity. On the other hand, a sulfide solid state electrolyte material containing bridging sulfur exhibits high reactivity and therefore reacts with the electrode active material such that a high-resistance layer is generated on an interface between the two materials, leading to an increase in interface resistance. In particular, generation of a high-resistance layer is advanced when heat is applied to the sulfide solid state electrolyte material, as in the techniques disclosed in JP-A-2008-270137, JP-A-2008-103244 and JP-A-8-138724, leading to a dramatic increase in interface resistance.

### SUMMARY OF INVENTION

The invention provides an electrode active material layer that is capable of suppressing generation of a high-resistance layer caused by a reaction between an electrode active material and a sulfide solid state electrolyte material and therefore has low interface resistance.

A first aspect of the invention relates to an electrode active material layer including: an electrode active material; and a sulfide solid state electrolyte material which is fused to a surface of the electrode active material and is substantially free of a bridging sulfur.

Further, a second aspect of the invention relates to an all solid state battery including: a positive electrode active material layer; a negative electrode active material layer; and a solid state electrolyte layer formed between the positive electrode active material layer and the negative electrode active material layer. In this all solid state battery, at least one of the positive electrode active material layer and the negative electrode active material layer is an electrode active material layer including an electrode active material and a sulfide solid state electrolyte material which is fused to a surface of the electrode active material and is substantially free of a bridging sulfur.

Further, a third aspect of the invention relates to a method for manufacturing an electrode active material layer containing an electrode active material and a sulfide solid state electrolyte material which is fused to a surface of the electrode active material and is substantially free of a bridging sulfur. This manufacturing method includes: obtaining an electrode active material layer forming composite material by mixing together the electrode active material and the sulfide solid state electrolyte material; pressure-molding the electrode active material layer forming composite material; and performing heat treatment on the electrode active material layer forming composite material to soften the sulfide solid state electrolyte material contained in the electrode active material layer forming composite material.

Further, a fourth aspect of the invention relates to a method for manufacturing an all solid state battery having an electrode active material layer that contains an electrode active material and a sulfide solid state electrolyte material which is fused to a surface of the electrode active material and is substantially free of a bridging sulfur. This manufacturing method includes: obtaining an electrode active material layer forming composite material by mixing together the electrode active material and the sulfide solid state electrolyte material; preparing a processing composite material containing the electrode active material layer forming composite material; pressure-molding the processing composite material; and performing heat treatment on the processing composite material to soften the sulfide solid state electrolyte material contained in the electrode active material layer forming composite material.

### BRIEF DESCRIPTION OF DRAWINGS

The foregoing and further objects, features, and advantages of the invention will become apparent from the following description of example embodiments with reference to the accompanying drawings, wherein like numerals are used to represent like elements and wherein:

FIG. 1 is a schematic sectional view showing an example of an electrode active material layer according to a first embodiment of the invention;

FIG. 2 is a schematic sectional view showing an example of a power generation element of an all solid state battery according to a second embodiment of the invention;

FIG. 3 is an illustrative view illustrating an example of a manufacturing method for the electrode active material layer according to a third embodiment of the invention;

FIGS. 4A to 4G are schematic sectional views illustrating a processing composite material preparation step according to a fourth embodiment of the invention;

FIGS. 5A to 5D are schematic sectional views illustrating the processing composite material preparation step according to a fourth embodiment of the invention;

FIG. 6 is an illustrative view illustrating a method of creating an evaluation solid state battery according to a first example;

FIG. 7 shows results relating to a filling rate of evaluation solid state batteries obtained in the first example and first to third comparative examples;

FIG. 8 shows interface resistance measurement results relating to the evaluation solid state batteries obtained in the first example and the first to third comparative examples;

FIG. 9 is an illustrative view illustrating a two-phase pellet created in a reference example; and

FIG. 10 shows results of Raman spectroscopy measurement obtained in relation to the two-phase pellet.

### DETAILED DESCRIPTION OF EMBODIMENTS

An electrode active material layer, an all solid state battery, a manufacturing method for the electrode active material layer, and a manufacturing method for the all solid state battery according to embodiments of the invention will be described in detail below.

First, an electrode active material layer according to a first embodiment of the invention will be described. The electrode active material layer according to this embodiment contains an electrode active material and a sulfide solid state electrolyte material which is fused to a surface of the electrode active material and is substantially free of bridging sulfur.

According to this embodiment, by employing a sulfide solid state electrolyte material that is substantially free of bridging sulfur, generation of a high-resistance layer caused by a reaction between the electrode active material and the sulfide solid state electrolyte material can be suppressed, and as a result, an electrode active material layer having low interface resistance can be obtained. Further, by using this type of electrode active material as an electrode body, an all solid state battery having low interface resistance can be obtained. Furthermore, the sulfide solid state electrolyte material according to this embodiment is fused to the surface of the electrode active material. In this embodiment, the term “fused” indicates a condition in which the sulfide solid state electrolyte material, having been softened by heat treatment, is then cooled so as to become adhered to the surface of the electrode active material. The sulfide solid state electrolyte material fused to the surface of the electrode active material can typically be obtained by performing a pressure molding step and a heat treatment step to be described hereinafter. By fusing the sulfide solid state electrolyte material to the surface of the electrode active material, a contact area between particles of the sulfide solid state electrolyte material increases, and therefore an ion conduction path is formed more easily.

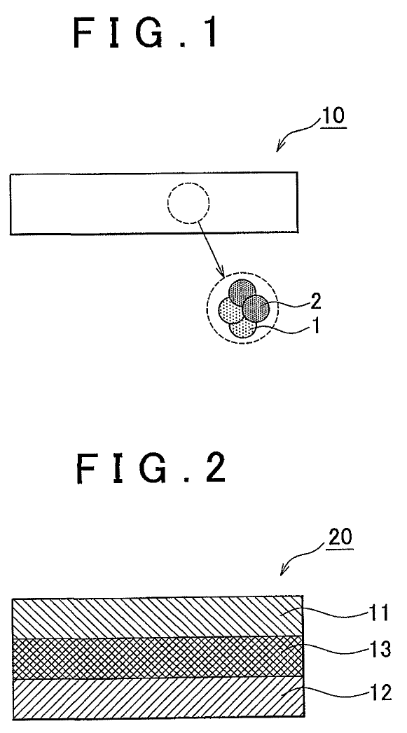

FIG. 1 is a schematic sectional view showing an example of the electrode active material layer according to this embodiment. An electrode active material layer 10 shown in FIG. 1 includes an electrode active material 1, and a sulfide solid state electrolyte material 2 which is fused to the surface of the electrode active material 1 and is substantially free of bridging sulfur. Note that it is possible to confirm that the sulfide solid state electrolyte material 2 is fused by observing an interface between the sulfide solid state electrolyte material 2 and the electrode active material 1 using a scanning electron microscope (SEM), for example. Respective constitutions of the electrode active material layer according to this embodiment will be described below.

First, the sulfide solid state electrolyte material that is substantially free of bridging sulfur will be described. Here, “bridging sulfur” denotes sulfur elements that are generated during manufacture of the sulfide solid state electrolyte material to form bridging bonds (—S— bonds) between sulfides contained in the sulfide solid state electrolyte material. The phrase “the sulfide solid state electrolyte material is substantially free of bridging sulfur” means that the proportion of bridging sulfur contained in the sulfide solid state electrolyte material is small enough to ensure that the interface resistance of the sulfide solid state electrolyte material is not affected by a reaction between bridging sulfur and the electrode active material. In this embodiment, the proportion of bridging sulfur in the sulfide solid state electrolyte material may be set at no more than 10 mol % but is preferably set at no more than 5 mol %.

Furthermore, the fact that “the sulfide solid state electrolyte material is substantially free of bridging sulfide” can be confirmed by measuring a Raman spectroscopy spectrum of the sulfide solid state electrolyte material. For example, when the sulfide solid state electrolyte material is constituted by a Li₂S—P₂S₅ material to be described below, a peak of an S₃P—S—PS₃ unit (a P₂S₇ unit) containing bridging sulfur typically appears at 402 cm⁻¹. In this embodiment, this peak is preferably not detected. Further, a peak of a PS₄ unit typically appears at 417 cm⁻¹. In this embodiment, an intensity I₄₀₂ at 402 cm⁻¹ is preferably smaller than an intensity I₄₁₇ at 417 cm⁻¹. More specifically, the intensity I₄₀₂ is preferably no more than 70%, for example, of the intensity I₄₁₇, more preferably no more than 50%, and even more preferably no more than 35%. The fact that “the sulfide solid state electrolyte material is substantially free of bridging sulfur” may be confirmed using a raw material composition ratio or a measurement result of nuclear magnetic resonance (NMR) obtained when the sulfide solid state electrolyte material is synthesized, rather than the measurement result of the Raman spectroscopy spectrum.

Specifically, the sulfide solid state electrolyte material that is substantially free of bridging sulfur may be manufactured using a raw material composition containing lithium sulfide (Li₂S) and a sulfide of an element from the thirteenth to fifteenth groups. An amorphization method, for example, may be used as a method of manufacturing the sulfide solid state electrolyte material (sulfide glass) using this raw material composition. Examples of amorphization methods include a mechanical milling method and a melt extraction method, but a mechanical milling method is preferably used since processing can be performed at room temperature, enabling simplification of the manufacturing process.

Aluminum (Al), silicon (Si), germanium (Ge), phosphorus (P), arsenic (As), or antimony (Sb), for example, may be used as the element from the thirteenth to fifteenth groups. Further, aluminum sulfide (Al₂S₃), silicon sulfide (SiS₂), germanium sulfide (GeS₂), diphosphorus trisulfide (P₂S₃), diphosphorus pentasulfide (P₂S₅), diarsenic trisulfide (As₂S₃), or diantimony trisulfide (Sb₂S₃), for example, may be used as the sulfide of the element from the thirteenth to fifteenth groups. In this embodiment, a sulfide from the fourteenth or fifteenth group is preferably used. In this embodiment, the sulfide solid state electrolyte material may be a Li₂S—P₂S₅ material (a material constituted by Li₂S and P₂S₅), a Li₂S—SiS₂ material (a material constituted by Li₂S and SiS₂), a Li₂S—GeS₂ material (a material constituted by Li₂S and GeS₂), or a Li₂S—Al₂S₃ material (a material constituted by Li₂S and Al₂S₃), but is preferably a Li₂S—P₂S₅ material due to the superior Li ion conductivity of this material.

Further, when the sulfide solid state electrolyte material is manufactured using a raw material composition containing Li₂S, the sulfide solid state electrolyte material may be substantially free of Li₂S. The phrase “the sulfide solid state electrolyte material is substantially free of Li₂S” means that the sulfide solid state electrolyte material is substantially free of Li₂S derived from the raw material composition used to manufacture the sulfide solid state electrolyte material. The Li₂S is easily affected by heat, similarly to bridging sulfur. The fact that “the sulfide solid state electrolyte material is substantially free of Li₂S” may be confirmed by measuring the sulfide solid state electrolyte material using an X ray diffraction analysis method. More specifically, when a result of an X ray diffraction analysis method performed on the sulfide solid state electrolyte material indicates that a Li₂S peak (2θ=27.0°, 31.2°, 44.8°, 53.1°) is absent, it may be determined that the sulfide solid state electrolyte material is substantially free of Li₂S. Note that when the proportion of Li₂S in the raw material composition is too large, the sulfide solid state electrolyte material is more likely to contain Li₂S, and conversely, when the proportion of Li₂S in the raw material composition is too small, the manufactured sulfide solid state electrolyte material is more likely to contain the aforementioned bridging sulfur.

Furthermore, when the sulfide solid state electrolyte material is substantially free of bridging sulfur and Li₂S, the sulfide solid state electrolyte material typically has an ortho-composition or a composition close to an ortho-composition. An ortho-composition is typically a composition having a maximum degree of hydration from among oxoacids obtained by hydrating an identical oxide. In this embodiment, an ortho-composition denotes a sulfide having a crystalline composition which contains a larger amount of Li₂S than in other sulfides. For example, Li₃PS₄ corresponds to an ortho-composition in a Li₂S—P₂S₅ material, Li₃AlS₃ corresponds to an ortho-composition in a Li₂S—Al₂S₃ material, Li₄SiS₄ corresponds to an ortho-composition in a Li₂S—SiS₂ material, and Li₄GeS₄ corresponds to an ortho-composition in a Li₂S—GeS₂ material. In the case of a Li₂S—P₂S₅ material, for example, the ratio of Li₂S and P₂S₅ for obtaining an ortho-composition is Li₂S:P₂S₅=75:25 in terms of molar conversion. Similarly, in the case of a Li₂S—Al₂S₃ material, the ratio of Li₂S and Al₂S₃ for obtaining an ortho-composition is Li₂S:Al₂S₃=75:25 in terms of molar conversion. In the case of a Li₂S—SiS₂ material, on the other hand, the ratio of Li₂S and SiS₂ for obtaining an ortho-composition is Li₂S:SiS₂=66.7:33.3 in terms of molar conversion. Similarly, in the case of a Li₂S—GeS₂ material, the ratio of Li₂S and GeS₂ for obtaining an ortho-composition is Li₂S:GeS₂=66.7:33.3 in terms of molar conversion.

In a case where the raw material composition contains Li₂S and P₂S₅, the raw material composition may contain only Li₂S and P₂S₅ or may contain another compound. The ratio between the Li₂S and the P₂S₅ in terms of molar conversion may be Li₂S:P₂S₅=72 to 78:22 to 28, but is preferably Li₂S:P₂S₅=73 to 77:23 to 27 and more preferably Li₂S:P₂S₅=74 to 76:24 to 26. In other words, the ratio of P₂S₅ relative to Li₂S may be no less than 11/39 and no more than 14/36, but is preferably no less than 23/77 and no more than 27/73, and more preferably no less than 6/19 and no more than 13/37. By setting the composition of the two substances in a range including the ratio (Li₂S:P₂S₅=75:25) for obtaining an ortho-composition and the vicinity thereof, generation of a high-resistance layer can be suppressed even further. Note that when the raw material composition contains Li₂S and Al₂S₃, the composition of the raw material composition and the ratio between the Li₂S and the Al₂S₃ may be set similarly to the above case, in which the raw material composition contains Li₂S and P₂S₅.

Meanwhile, in a case where the raw material composition contains Li₂S and SiS₂, the raw material composition may contain only Li₂S and SiS₂ or may contain another compound. The ratio between the Li₂S and the SiS₂ in terms of molar conversion may be Li₂S:SiS₂=63 to 70:30 to 37, but is preferably Li₂S:SiS₂=64 to 69:31 to 36 and more preferably Li₂S:SiS₂=65 to 68:32 to 35. In other words, the ratio of SiS₂ relative to Li₂S may be no less than 3/7 and no more than 37/63, but is preferably no less than 31/69 and no more than 9/16, and more preferably no less than 8/17 and no more than 7/13. By setting the proportions of the two substances in a range including the ratio (Li₂S:SiS₂=66.7:33.3) for obtaining an ortho-composition and the vicinity thereof, generation of a high-resistance layer can be suppressed even further. Note that when the raw material composition contains Li₂S and GeS₂, the composition of the raw material composition and the ratio between the Li₂S and the GeS₂ may be set similarly to the above case, in which the raw material composition contains Li₂S and SiS₂.

Furthermore, when Li₂S is used in the raw material composition, an amount of intermixed impurities is preferably as small as possible. As a result, secondary reactions can be suppressed. A method described in Japanese Patent Application Publication No. 7-330312 (JP-A-7-330312), for example, may be used as a method of synthesizing the Li₂S. Further, the Li₂S is preferably refined using a method described in WO2005/040039 or the like. Further, in addition to Li₂S and a sulfide of an element from the thirteenth to fifteenth groups, the raw material composition may contain at least one type of lithium ortho-oxoacid salt selected from the group consisting of Li₃PO₄, Li₄SiO₄, Li₄GeO₄, Li₃BO₃ and Li₃AlO₃. By adding this type of lithium ortho-oxoacid salt, a more stable sulfide solid state electrolyte material can be obtained.

Further, the sulfide solid state electrolyte material that is substantially free of bridging sulfur may be sulfide glass or crystallized sulfide glass. Sulfide glass is softer than crystallized sulfide glass and is therefore capable of absorbing expansion and contraction of the electrode active material, leading to an improvement in the cycle characteristic. On the other hand, crystallized sulfide glass exhibits higher Li ion conductivity than sulfide glass. Further, sulfide glass can be obtained by performing the aforementioned amorphization treatment on the raw material composition, for example, while crystallized sulfide glass can be obtained by subjecting sulfide glass to heat treatment at a temperature no lower than the crystallization temperature, for example. In other words, crystallized sulfide glass can be obtained by performing amorphization treatment and heat treatment successively on the raw material composition. Depending on the heat treatment conditions, bridging sulfur and Li₂S may be generated and a stable phase may be generated. Therefore, in this embodiment, a heat treatment temperature and a heat treatment period may be adjusted so that these components are not generated. In particular, the crystallized sulfide glass according to this embodiment need not have a stable phase.

Furthermore, a Li ion conductivity value of the sulfide solid state electrolyte material according to this embodiment may be set high. The Li ion conductivity at room temperature may be set at no less than 10⁻⁵ S/cm, for example, but is preferably set at no less than 10⁻⁴ S/cm.

The sulfide solid state electrolyte material according to this embodiment may take a particulate shape, a spherical shape, or an oval sphere shape, for example. When the sulfide solid state electrolyte material takes a particulate shape, an average particle diameter thereof may be set between 0.1 μm and 50 μm, for example. The sulfide solid state electrolyte material content of the electrode active material layer may be set between 1% and 80% by weight, for example, but is preferably between 10% and 70% by weight and more preferably between 15% and 50% by weight. When the sulfide solid state electrolyte material content is too small, it may be impossible to form a sufficient ion conduction path, and when the sulfide solid state electrolyte material content is too large, the electrode active material content decreases relatively, thereby increasing the likelihood of a reduction in capacity.

Next, the electrode active material according to this embodiment will be described. The electrode active material according to this embodiment generates a high-resistance layer when it reacts with the sulfide solid state electrolyte material containing bridging sulfur according to the related art, but is less likely to react with the sulfide solid state electrolyte material according to this embodiment. Further, the electrode active material according to this embodiment may be a negative electrode active material but is preferably a positive electrode active material so that an increase in interface resistance occurring when a high-resistance layer is generated can be suppressed effectively.

The positive electrode active material according to this embodiment differs depending on the type of ion to be conducted by the intended all solid state battery. For example, when the intended all solid state battery is an all solid state lithium secondary battery, the positive electrode active material occludes and discharges lithium ions.

The positive electrode active material used in this embodiment may be an oxide positive electrode active material, for example. An oxide positive electrode active material reacts easily with the sulfide solid state electrolyte material containing bridging sulfur according to the related art but is less likely to react with the sulfide solid state electrolyte material according to this embodiment, and therefore the effects described above are exhibited more easily. Further, by using an oxide positive electrode active material, an electrode active material layer having a high energy density can be obtained. A positive electrode active material expressed by a general formula LiₓM_{y}O_{z} (where M is a transition metal element, x=0.02 to 2.2, y=1 to 2, and z=1.4 to 4) may be cited as an example of an oxide positive electrode active material used in an all solid state lithium battery. In this general formula, M may be at least one element selected from the group consisting of (Co), (Mn), (Ni), (V), (Fe) and Si, but is preferably at least one element selected from the group consisting of Co, Ni and Mn. More specifically, the oxide positive electrode active material may be LiCoO₂, LiMnO₂, LiNiO₂, LiVO₂, LiNi_{1/3}CO_{1/3}Mn_{1/3}O₂, LiMn₂O₄, Li(Ni_{0.5}Mn_{1.5})O₄, Li₂FeSiO₄, or Li₂MnSiO₄. The positive electrode active material may also be an olivine positive electrode active material such as LiFePO₄ or LiMnPO₄.

The positive electrode active material may take a particulate shape, a spherical shape, or an oval sphere shape, for example. When the positive electrode active material takes a particulate shape, an average particle diameter thereof may be set between 0.1 μm and 50 μm, for example. Further, the positive electrode active material content of the electrode active material layer (positive electrode active material layer) may be set between 10% and 99% by weight, for example, but is preferably between 20% and 90% by weight.

A negative electrode active material according to this embodiment may be a metal active material or a carbon active material, for example. Examples of metal active materials may include indium (In), Al, Si, tin (Sn), and so on. Meanwhile, mesocarbon microbeads (MCMB), highly oriented pyrolytic graphite (HOPG), hard carbon, or soft carbon, for example, may be used as the carbon active material.

The negative electrode active material may take a particulate shape, a spherical shape, or an oval sphere shape, for example. When the negative electrode active material takes a particulate shape, an average particle diameter thereof may be set between 0.1 μm and 50 μm, for example. Further, the negative electrode active material content of the electrode active material layer (negative electrode active material layer) may be set between 10% and 99% by weight, for example, but is preferably between 20% and 90% by weight.

The electrode active material layer according to this embodiment may further include a conductive material. By adding a conductive material, the conductivity of the electrode active material layer can be improved. The conductive material may be acetylene black, Ketjen black, or carbon fiber, for example. On the other hand, the electrode active material layer according to this embodiment may include a binding material. By adding a binding material, the electrode active material layer can be made flexible. A fluorine-containing resin or the like, for example, may be used as the binding material.

Further, the electrode active material layer according to this embodiment may have a high filling rate, leading to an improvement in energy density. Moreover, when the filling rate is high, the contact area between particles of the sulfide solid state electrolyte material increases, and as a result, the ion conduction path is formed more easily. The filling rate of the electrode active material layer may be set at no less than 85%, for example, but is preferably no less than 90% and more preferably no less than 93%. The filling rate of the electrode active material layer can be calculated using the following method. A total volume obtained by dividing the weight of each material (the positive electrode active material, the sulfide solid state electrolyte material, and so on) contained in the electrode active material layer by a true density of each material is set as “volume of electrode active material layer calculated from true density”, a volume calculated from dimensions of the actual electrode active material layer is set as “volume of actual electrode active material layer”, and the filling rate (%) is obtained from a following equation (1).

Filling rate (%)=(volume of electrode active material layer calculated from true density)/(volume of actual electrode active material layer)×100 (1)

The electrode active material layer according to this embodiment may take a sheet form or a pellet form, for example. A thickness of the electrode active material layer differs according to the type of intended all solid state battery, but may be set between 1 μm and 200 μm.

Further, the content of the sulfide solid state electrolyte material substantially free of bridging sulfur in the electrode active material layer may be greater on a surface thereof that contacts a solid state electrolyte layer. Thus, when a sulfide solid state electrolyte material containing bridging sulfur is used in the solid state electrolyte layer, contact between the electrode active material and the sulfide solid state electrolyte material containing bridging sulfur can be suppressed effectively. Furthermore, in this embodiment, a thin film layer constituted by sulfide solid state electrolyte material that is substantially free of bridging sulfur may be provided on a surface of the electrode active material layer that contacts the solid state electrolyte layer.

Next, an all solid state battery according to a second embodiment of the invention will be described. The all solid state battery according to this embodiment includes a positive electrode active material layer, a negative electrode active material layer, and a solid state electrolyte layer formed between the positive electrode active material layer and the negative electrode active material layer, in which at least one of the positive electrode active material layer and the negative electrode active material layer is the electrode active material layer according to the first embodiment described above.

According to this embodiment, by using the electrode active material layer described above as at least one of the positive electrode active material layer and the negative electrode active material layer, an all solid state battery having low interface resistance can be obtained.

FIG. 2 is a schematic sectional view showing an example of a power generation element of the all solid state battery according to this embodiment. A power generation element 20 shown in FIG. 2 includes a positive electrode active material layer 11, a negative electrode active material layer 12, and a solid state electrolyte layer 13 formed between the positive electrode active material layer 11 and the negative electrode active material layer 12. Further, in this embodiment, at least one of the positive electrode active material layer 11 and the negative electrode active material layer 12 is the electrode active material layer described above. In this embodiment, the positive electrode active material layer 11 may be the electrode active material layer described above. Since the positive electrode active material layer 11 is unlikely to react with the sulfide solid state electrolyte material that is substantially free of bridging sulfur, a high-resistance layer is unlikely to be generated, and therefore the effects of this embodiment can be exhibited sufficiently. Respective constitutions of the all solid state battery according to this embodiment will be described below.

In this embodiment, at least one of the positive electrode active material layer and the negative electrode active material layer is the electrode active material layer described above. The electrode active material layer is similar to that described in the first embodiment, and therefore description thereof has been omitted. Further, the positive electrode active material layer or the negative electrode active material layer not corresponding to the electrode active material layer according to the first embodiment has a similar constitution to a typical positive electrode active material layer or negative electrode active material layer.

The solid state electrolyte layer according to this embodiment is formed between the positive electrode active material layer and the negative electrode active material layer, and contains at least a solid state electrolyte material. In this embodiment, the solid state electrolyte material used in the solid state electrolyte layer may be a sulfide solid state electrolyte material. Further, the sulfide solid state electrolyte material used as the solid state electrolyte material may be substantially free of bridging sulfur, but bridging sulfur may be substantially included therein to raise the ion conductivity. In the case of a sulfide solid state electrolyte material substantially containing bridging sulfur, the proportion of the bridging sulfur contained in the sulfide solid state electrolyte material may be set at 20 mol % or more, but is preferably 40 mol % or more. The fact that “the sulfide solid state electrolyte material substantially includes bridging sulfur” may be confirmed from a measurement result of the Raman spectroscopy spectrum of the sulfide solid state electrolyte material, the raw material composition ratio, or an NMR measurement result.

Here, the solid state electrolyte material used in the solid state electrolyte layer may be a Li₂S—P₂S₅ material, and in this case, an S₃P—S—PS₃ peak may exist in the Raman spectroscopy spectrum of the solid state electrolyte material. As noted above, the S₃P—S—PS₃ peak typically appears at 402 cm⁻¹. In this embodiment, the intensity I₄₀₂ at 402 cm⁻¹ may be greater than the intensity I₄₁₇ at 417 cm⁻¹. More specifically, I₄₀₂/I₄₁₇ may be set at no less than 1.1, but is preferably no less than 1.3 and more preferably no less than 1.6.

Further, the solid state electrolyte material used in the solid state electrolyte layer may be manufactured using a raw material composition containing Li₂S and a sulfide of an element from the thirteenth to fifteenth groups. The Li₂S and the sulfide of an element from the thirteenth to fifteenth groups are as described in the first embodiment.

In this embodiment in particular, the solid state electrolyte material used in the solid state electrolyte layer may be crystallized sulfide glass represented by a chemical formula Li₇P₃S₁₁ since this compound exhibits particularly favorable Li ion conductivity. A method described in Japanese Patent Application Publication No. 2005-228570 (JP-A-2005-228570), for example, may be used as a method of synthesizing the Li₇P₃S₁₁. More specifically, the Li₇P₃S₁₁ may be synthesized by mixing Li₂S and P₂S₅ at a molar ratio of 70:30, amorphizing the mixture using a ball mill to obtain sulfide glass, and then subjecting the obtained sulfide glass to heat treatment at 150° C. to 360° C.

The sulfide solid state electrolyte material content of the solid state electrolyte layer may be large, and in this embodiment in particular, the solid state electrolyte layer may be constituted by the sulfide solid state electrolyte material alone. In so doing, an all solid state battery having a higher output can be obtained. Further, a thickness of the solid state electrolyte layer may be set between 0.1 μm and 1000 μm, for example, but is preferably set between 0.1 μm and 300 μm.

The all solid state battery according to this embodiment includes at least the positive electrode active material layer, the solid state electrolyte layer, and the negative electrode active material layer described above. Further, the all solid state battery typically includes a positive electrode collector for performing current collection on the positive electrode active material layer, and a negative electrode collector for performing current collection on the negative electrode active material layer. Stainless used steel (SUS), aluminum, nickel, iron, titanium, carbon, and so on may be cited as examples of materials for the positive electrode collector, from which SUS is preferable. Meanwhile, the material of the negative electrode collector may be SUS, copper, nickel, or carbon, for example, but is preferably SUS. Further, the thickness, shape, and so on of the positive electrode collector and negative electrode collector may be selected appropriately in accordance with the application of the all solid state battery. Further, a typical battery case for an all solid state battery may be used as a battery case employed in this embodiment. The battery case may be made of SUS, for example. Furthermore, the power generation element of the all solid state battery according to this embodiment may be formed in the interior of an insulation ring.

As described above, the all solid state battery according to this embodiment includes a power generation element constituted by the positive electrode active material layer, the negative electrode active material layer, and the solid state electrolyte layer. Further, a filling rate of the power generation element may be set high, leading to an improvement in energy density. Moreover, when the filling rate is high, the contact area between particles of the sulfide solid state electrolyte material increases, and as a result, the ion conduction path is formed more easily. The filling rate of the power generation element may be set at no less than 85% but is preferably no less than 90% and more preferably no less than 93%. The filling rate of the power generation element can be calculated using the following method. A total volume obtained by dividing the weight of each material (the positive electrode active material, the negative electrode active material, the sulfide solid state electrolyte material, and so on) contained in the power generation element by the true density of each material is set as “volume of power generation element calculated from true density”, a volume calculated from dimensions of the actual power generation element is set as “volume of actual power generation element”, and the filling rate (%) is obtained from a following equation (2).

Filling rate (%)=(volume of power generation element calculated from true density)/(volume of actual power generation element)×100 (2)

The all solid state battery according to this embodiment may be an all solid state lithium battery, an all solid state sodium battery, an all solid state magnesium battery, or an all solid state calcium battery, but is preferably an all solid state lithium battery or an all solid state sodium battery and more preferably an all solid state lithium battery. Further, the all solid state battery according to this embodiment may be a primary battery but is preferably a secondary battery since a secondary battery can be charged/discharged repeatedly and is therefore useful as a vehicle-installed battery, for example. The all solid state battery according to this embodiment may be coin-shaped, laminated, cylindrical, or angular, for example, but is preferably angular or laminated and more preferably laminated.

As long as the all solid state battery described above can be obtained, there are no particular limitations on the method of manufacturing the all solid state battery according to this embodiment, and a typical manufacturing method for an all solid state battery may be employed. An example of a manufacturing method for an all solid state battery will be described in detail below in a third embodiment of the invention.

Next, a manufacturing method for an electrode active material layer according to a third embodiment of the invention will be described. The manufacturing method for an electrode active material layer according to this embodiment is a method of manufacturing an electrode active material layer containing an electrode active material and a sulfide solid state electrolyte material which is fused to a surface of the electrode active material and is substantially free of bridging sulfur. The manufacturing method includes a mixing step for mixing together the electrode active material and the sulfide solid state electrolyte material to obtain an electrode active material layer forming composite material, a pressure molding step for pressure molding the electrode active material layer forming composite material, and a heat treatment step for performing heat treatment to soften the sulfide solid state electrolyte material contained in the electrode active material layer forming composite material.

According to this embodiment, a sulfide solid state electrolyte material substantially free of bridging sulfur is used, and therefore, even though the pressure molding step and the heat treatment step are performed, a high-resistance layer generated by a reaction between the electrode active material and the sulfide solid state electrolyte material can be suppressed. As a result, an electrode active material layer having low interface resistance can be obtained.

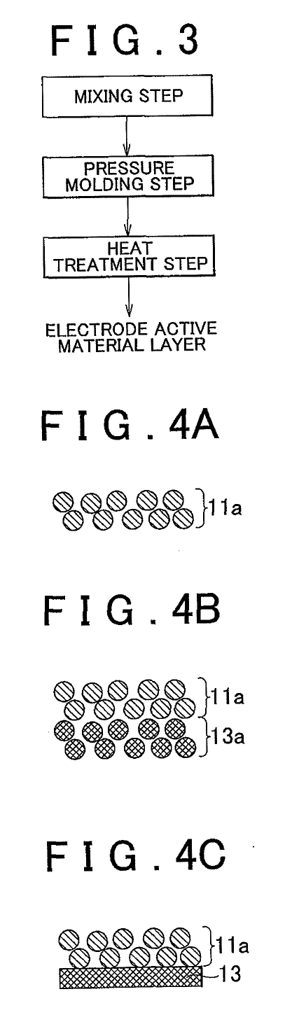

FIG. 3 is an illustrative view illustrating an example of the manufacturing method for an electrode active material layer according to this embodiment. In FIG. 3, first, an electrode active material (LiCoO₂, for example) and a sulfide solid state electrolyte material that is substantially free of bridging sulfur (sulfide glass having a 75 Li₂S-25 P₂S₅ composition, for example) are intermixed to obtain an electrode active material layer forming composite material (mixing step). Next, pressure molding is performed on the electrode active material layer forming composite material by applying a desired pressure (pressure molding step). Next, heat treatment is performed to soften the sulfide solid state electrolyte material contained in the electrode active material layer forming composite material (heat treatment step). As a result, an electrode active material layer containing an electrode active material and a sulfide solid state electrolyte material which is fused to the surface of the electrode active material and is substantially free of bridging sulfur, is obtained.

Each step of the manufacturing method for an electrode active material layer according to this embodiment will now be described. Note that each of the steps to be described below may be performed in an inert gas atmosphere (an argon atmosphere, for example). Further, the steps to be described below may be performed in an atmosphere having a low dew point.

First, the mixing step according to this embodiment will be described. In the mixing step according to this embodiment, the electrode active material is mixed with the sulfide solid state electrolyte material that is substantially free of bridging sulfur to obtain the electrode active material layer forming composite material. The electrode active material and sulfide solid state electrolyte material used in this embodiment are as described in the first embodiment, and therefore description thereof has been omitted. Further, there are no particular limitations on the method employed to mix the electrode active material and the sulfide solid state electrolyte material, and the materials may be mixed until a desired dispersion condition is obtained.

Next, the pressure molding step according to this embodiment will be described. In the pressure molding step according to this embodiment, the electrode active material layer forming composite material is pressure-molded. The pressure applied to the electrode active material layer forming composite material may be set at a sufficient pressure for obtaining the desired filling rate. More specifically, the pressure may be set at 0.01 ton/cm² to 10 ton/cm², but is preferably 0.3 ton/cm² to 8 ton/cm² and more preferably 1 ton/cm² to 5 ton/cm². Note that there are no particular limitations on the pressure application period, and this period may be set to obtain the desired filling rate. Further, pressure molding may be performed using a commercially available pressure molding device. Furthermore, there are no particular limitations on the pressure application method, and planar pressing or roll pressing may be employed.

Next, the heat treatment step according to this embodiment will be described. In the heat treatment step according to this embodiment, heat treatment is performed to soften the sulfide solid state electrolyte material contained in the electrode active material layer forming composite material. Note that here, “soften” includes not only softening the sulfide solid state electrolyte material but also fusing the sulfide solid state electrolyte material.

A heating temperature employed during the heat treatment step differs according to the type of sulfide solid state electrolyte material used. For example, to obtain an electrode active material layer containing a sulfide solid state electrolyte material constituted by sulfide glass, the heating temperature may be set no lower than a glass transition temperature required for glass transition of the sulfide solid state electrolyte material and lower than a crystallization temperature required for crystallization of the sulfide solid state electrolyte material. In this case, sulfide glass is comparatively soft, and therefore expansion and contraction of the electrode active material can be absorbed. As a result, an electrode active material layer exhibiting a superior cycle characteristic can be obtained. Here, the heating temperature differs according to the type of sulfide solid state electrolyte material, but the heating temperature may be set between 140° C. and 240° C., for example, and is preferably set within a range of 180° C. to 220° C.

Note that the glass transition temperature is a temperature at which a transition from a glass state to a rubber state occurs, i.e. a temperature at which sulfide glass softens. Further, the crystallization temperature is a temperature at which a transition from a rubber state to a fused state occurs. At the crystallization temperature, the sulfide solid state electrolyte material starts to fuse, and by cooling the sulfide solid state electrolyte material gradually thereafter, the fused part crystallizes.

To obtain an electrode active material layer containing a sulfide solid state electrolyte material constituted by crystallized sulfide glass, on the other hand, the heating temperature may be set no lower than the crystallization temperature of the sulfide solid state electrolyte material. In this case, an electrode active material layer exhibiting high ion conductivity can be obtained. Here, the heating temperature differs according to the type of sulfide solid state electrolyte material, but the heating temperature may be set between 140° C. and 350° C., for example, and is preferably set within a range of 240° C. to 300° C.

The heat treatment period may be selected appropriately in accordance with the type of the intended sulfide solid state electrolyte material. Further, a method that uses a kiln or a method that uses a drying oven for film deposition may be employed as the heat treatment method.

Further, there are no particular limitations on the order in which the pressure molding step and the heat treatment step according to this embodiment are performed. The two steps may be performed separately or in parallel. In this embodiment, the pressure molding step and the heat treatment step are preferably performed in parallel. In so doing, the electrode active material layer forming composite material is pressure-molded while the sulfide solid state electrolyte material is in a softened condition, and therefore an electrode active material layer having a high filling rate can be formed easily. Note that in this embodiment, a method in which the pressure molding step and the heat treatment step are performed simultaneously is referred to as a hot pressing method. More specifically, the hot pressing method according to this embodiment can be broadly divided into two types, namely a method in which the electrode active material layer forming composite material is first pressed and then subjected to heat treatment in a pressed condition and a method in which the electrode active material layer forming composite material is first subjected to heat treatment and then pressed in a heat-treated condition. Further, a commercially available hot pressing device may be used in the hot pressing method. Moreover, a hot roll pressing method may be employed in this embodiment.

When the two steps are performed separately, on the other hand, the filling rate can be improved by performing the heat treatment step first and then performing the pressure molding step while the sulfide solid state electrolyte material is in a softened condition. On the other hand, generation of a high-resistance layer can be suppressed by performing the pressure molding step first and then performing the heat treatment step after releasing the pressure.

Next, a manufacturing method for an all solid state battery according to a fourth embodiment of the invention will be described. The manufacturing method for an all solid state battery according to this embodiment is a method of manufacturing an all solid state battery having an electrode active material layer that contains an electrode active material and a sulfide solid state electrolyte material which is fused to a surface of the electrode active material and is substantially free of bridging sulfur. The method includes a mixing step for mixing together the electrode active material and the sulfide solid state electrolyte material to obtain an electrode active material layer forming composite material, a processing composite material preparation step for preparing a processing composite material containing the electrode active material layer forming composite material, a pressure molding step for pressure molding the processing composite material, and a heat treatment step for performing heat treatment to soften the sulfide solid state electrolyte material contained in the processing composite material.

According to this embodiment, a processing composite material containing a sulfide solid state electrolyte material substantially free of bridging sulfur is used, and therefore, even though the pressure molding step and the heat treatment step are performed, a high-resistance layer generated by a reaction between the electrode active material and the sulfide solid state electrolyte material can be suppressed. As a result, an all solid state battery having low interface resistance can be obtained. Each step of the manufacturing method for an all solid state battery according to this embodiment will be described below.

The mixing step according to this embodiment is similar to that of the manufacturing method for an electrode active material layer according to the second embodiment, and therefore description thereof has been omitted.

In the processing composite material preparation step according to this embodiment, a processing composite material containing the electrode active material layer forming composite material described above is prepared. The processing composite material is a composite material prior to implementation of the pressure forming step and the heat treatment step. Further, the processing composite material according to this embodiment can be broadly divided into an embodiment containing a powder-form electrode active material layer forming composite material and an embodiment containing a provisional electrode active material layer.

First, the embodiment in which the processing composite material contains a powder-form electrode active material layer forming composite material will be described. Further, for convenience, a specific example of the processing composite material will be described using a case in which the electrode active material layer forming composite material is a composite material (a positive electrode layer forming composite material) for forming the positive electrode active material layer. Note that a case in which the electrode active material layer forming composite material is a composite material (a negative electrode layer forming composite material) for forming the negative electrode active material layer is similar.

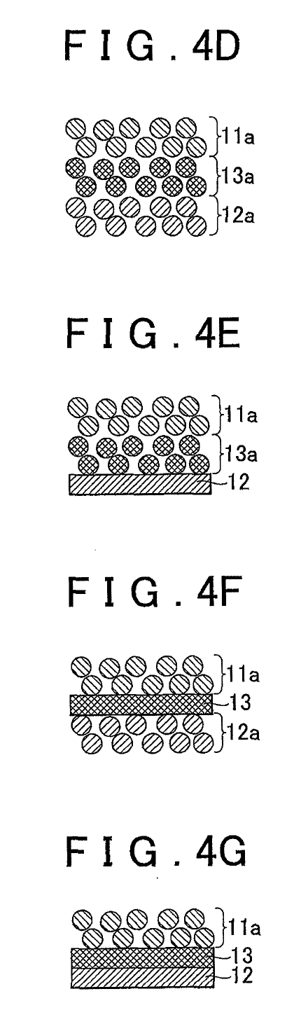

In FIG. 4A, the processing composite material contains only a powder-form positive electrode active material layer forming composite material 11a. In this case, the mixing step and the processing composite material preparation step are typically combined into a single step. Further, in FIG. 4A, a positive electrode active material layer is obtained by performing the pressure molding step and the heat treatment step on only the powder-form positive electrode active material layer forming composite material 11a. By forming a negative electrode active material layer and a solid state electrolyte layer on the obtained positive electrode active material layer, the power generation element 20 shown in FIG. 2 is obtained.

In FIG. 4B, the processing composite material contains the powder-form positive electrode active material layer forming composite material 11a and a powder-form solid state electrolyte layer forming material 13a. In this case, the processing composite material is obtained by adding the powder-form positive electrode active material layer forming composite material 11a onto the powder-form solid state electrolyte layer forming material 13a. Further, by performing the pressure molding step and the heat treatment step on the processing composite material, a positive electrode active material layer/solid state electrolyte layer complex is obtained. By forming a negative electrode active material layer on the obtained complex, the power generation element 20 shown in FIG. 2 is obtained. Further, as shown in FIG. 4C, the processing composite material may contain the powder-form positive electrode active material layer forming composite material 11a and a solid state electrolyte layer 13 molded in advance.

In FIG. 4D, the processing composite material contains the powder-form positive electrode active material layer forming composite material 11a, the powder-form solid state electrolyte layer forming material 13a, and a powder-form negative electrode active material layer forming composite material 12a. In this case, the processing composite material is obtained by adding the powder-form solid state electrolyte layer forming material 13a onto the powder-form negative electrode active material layer forming composite material 12a and then adding the powder-form positive electrode active material layer forming composite material 11a thereon. Further, by performing the pressure molding step and the heat treatment step on the processing composite material, a power generation element constituted by a positive electrode active material layer/solid state electrolyte layer/negative electrode active material layer is obtained. Further, as shown in FIGS. 4E to 4G, the processing composite material may contain the powder-form positive electrode active material layer forming composite material 11a, and the solid state electrolyte layer 13 and/or a negative electrode active material layer 12 molded in advance.

Next, the embodiment in which the processing composite material contains a provisional electrode active material layer will be described. Further, for convenience, a specific example of the processing composite material will be described using a case in which the electrode active material layer forming composite material is a positive electrode layer forming composite material. Note that a case in which the electrode active material layer forming composite material is a negative electrode layer forming composite material is similar.

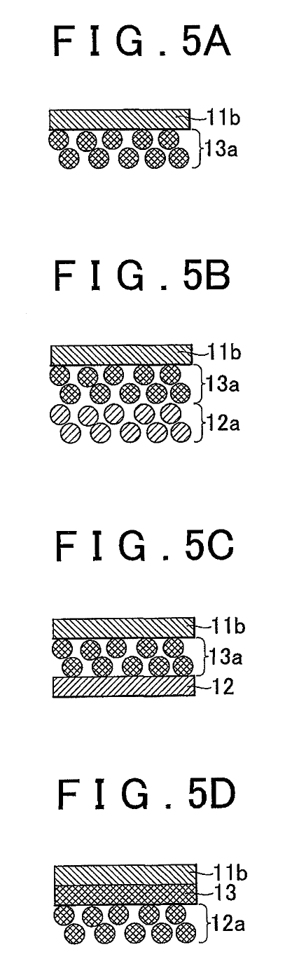

In FIG. 5A, the processing composite material contains a provisional positive electrode active material layer 11b and the powder-form solid state electrolyte layer forming material 13a. In this case, the processing composite material is obtained by adding the powder-form solid state electrolyte layer forming material 13a onto the provisional positive electrode active material layer 11b. Further, by performing the pressure molding step and the heat treatment step on the processing composite material, a positive electrode active material layer/solid state electrolyte layer complex is obtained. By forming a negative electrode active material layer on the obtained complex, the power generation element 20 shown in FIG. 2 is obtained. Further, as shown in FIG. 5B, the processing composite material may contain the provisional positive electrode active material layer 11b, the powder-form solid state electrolyte layer forming material 13a, and the powder-form negative electrode active material layer 12a. Moreover, as shown in FIGS. 5C and 5D, the processing composite material may contain the provisional positive electrode active material layer 11b, and the solid state electrolyte layer 13 or the negative electrode active material layer 12 molded in advance.

Further, although not shown specifically in the drawings, the processing composite material may contain the provisional positive electrode active material layer alone, the provisional positive electrode active material layer and the solid state electrolyte layer, or the provisional positive electrode active material layer, the solid state electrolyte layer, and the negative electrode active material layer.

The pressure molding step and the heat treatment step according to this embodiment are similar to those described in the third embodiment apart from the fact that the processing composite material is used instead of the electrode active material layer forming composite material, and therefore description of these steps has been omitted.

Examples of the first to third embodiments will now be described.

### First Example

First, synthesis of the sulfide solid state electrolyte material free of bridging sulfur will be described. Lithium sulfide (Li₂S) and diphosphorus pentasulfide (P₂S₅) were used as starting materials. Powders thereof were weighed inside an argon atmosphere glove box using a composition of xLi₂S.(100−x)P₂S₅ to obtain a molar ratio of x=75, whereupon the powders were mixed using an agate pestle to obtain a raw material composition. Next, 1 g of the obtained raw material composition was introduced into a 45 ml zirconia pot together with ten zirconia balls (Φ10 mm), whereupon the pot was tightly and completely sealed. The pot was then attached to a planetary ball mill device, whereupon mechanical milling was performed for 40 hours at a rotation speed of 370 rpm to obtain a sulfide solid state electrolyte material (sulfide glass, 75 Li₂S-25 P₂S₅). Note that the relationship of Li₂S:P₂S₅=75:25 (molar ratio) is a relationship for obtaining the aforesaid ortho-composition, and therefore the obtained sulfide solid state electrolyte material is free of bridging sulfur.

Next, an evaluation solid state battery was created in a glove box having an argon atmosphere and a dew point of −80° C. using the obtained sulfide solid state electrolyte material. First, 150 mg of the sulfide solid state electrolyte material free of bridging sulfur was prepared as a solid state electrolyte layer forming material. Further, a mixture containing a positive electrode active material (LiCoO₂) and the sulfide solid state electrolyte material free of bridging sulfur at a weight ratio of 7:3 (11.34 mg:4.86 mg) was prepared as a positive electrode active material layer forming composite material. Furthermore, a mixture containing a negative electrode active material (graphite) and the sulfide solid state electrolyte material free of bridging sulfur at a weight ratio of 5:5 (6.0 mg:6.0 mg) was prepared as a negative electrode active material layer forming composite material.

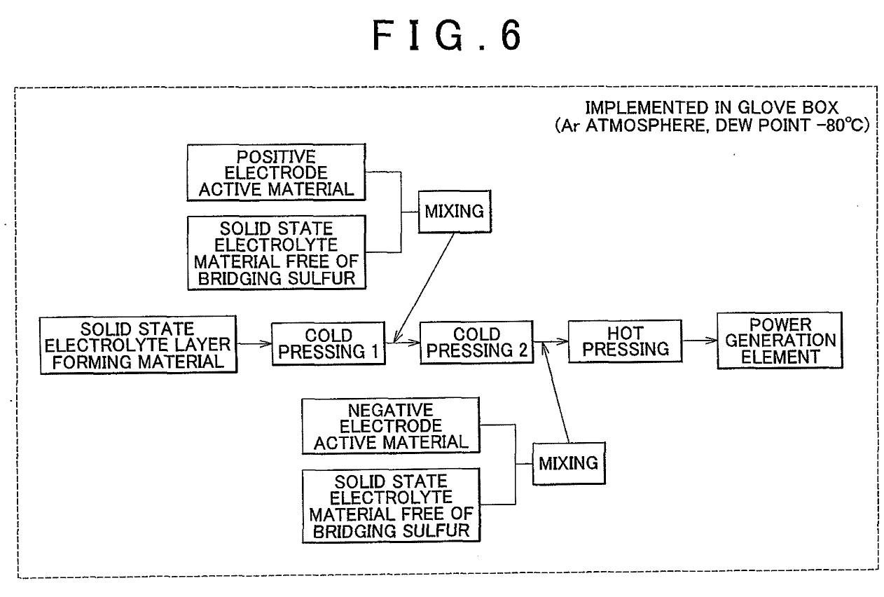

Next, the solid state electrolyte layer forming material was disposed in a φ11.3 mm molding jig and pressed under conditions of temperature 25° C., pressure 1.0 ton/cm², and pressing period one minute to obtain a solid state electrolyte layer (cold pressing 1 in FIG. 6). Next, the positive electrode active material layer forming composite material was added to the surface of the obtained solid state electrolyte layer, whereupon pressing was performed under conditions of temperature 25° C., pressure 1.0 ton/cm², and pressing period one minute to obtain a positive electrode active material layer/solid state electrolyte layer complex (cold pressing 2 in FIG. 6). Next, the negative electrode active material layer forming composite material was added to a surface of the solid state electrolyte layer on the side not formed with the positive electrode active material layer, whereupon a pressure of 2.0 ton/cm² was applied and heat treatment was performed (hot pressing in FIG. 6). The conditions of the heat treatment were set such that the temperature was raised from room temperature to 210° C. in approximately 30 minutes, held at 210° C. for 30 minutes, and then reduced to room temperature over approximately four hours. Note that the heat treatment was performed at a temperature no lower than the glass transition point and lower than the crystallization temperature of the sulfide solid state electrolyte material. As a result, a power generation element constituted by the positive electrode active material layer/solid state electrolyte layer/active material layer was obtained. The power generation element was then sandwiched by collectors made of SUS, whereupon the collectors were fixed by bolts at a confining pressure of 450 kgf/cm² to obtain the evaluation solid state battery. The obtained evaluation solid state battery was disposed in an Ar atmosphere desiccator.

### First Comparative Example

An evaluation solid state battery was obtained similarly to the first example except that the hot pressing of the first example was modified to cold pressing in which pressing was performed under conditions of temperature 25° C., pressure 2.0 ton/cm², and pressing period five hours.

### Second Comparative Example

In an xLi₂S.(100−x)P₂S₅ composition, a sulfide solid state electrolyte material (sulfide glass, 70 Li₂S-30 P₂S₅) containing bridging sulfur was obtained similarly to the first example except that here, x=70. An evaluation solid state battery was then obtained similarly to the first example except that the sulfide solid state electrolyte material containing bridging sulfur was used instead of a sulfide solid state electrolyte material free of bridging sulfur.

### Third Comparative Example

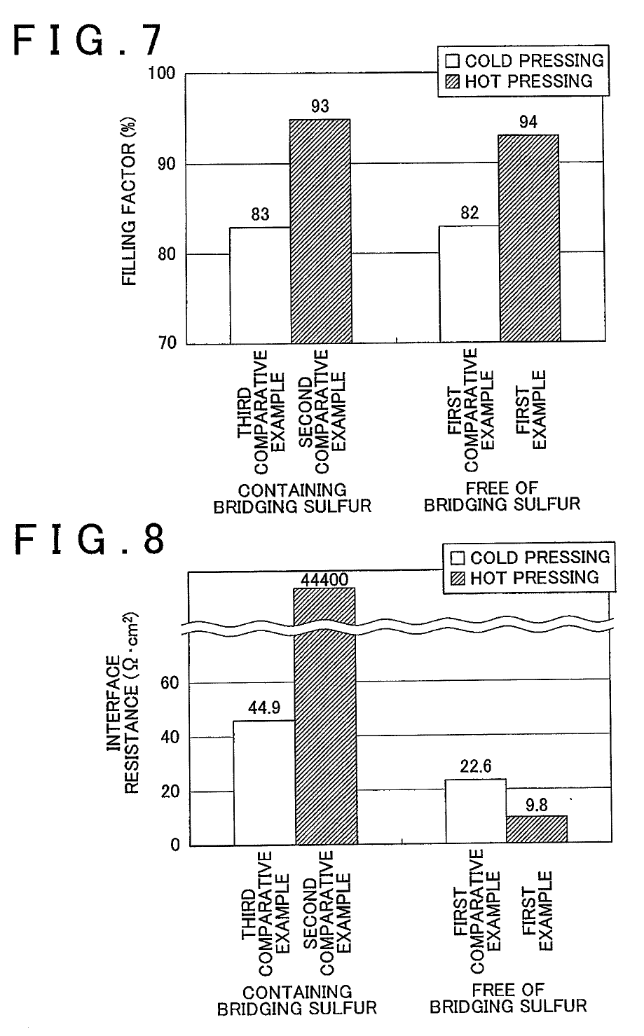

An evaluation solid state battery was obtained similarly to the second comparative example except that the hot pressing of the second comparative example was modified to cold pressing in which pressing was performed under conditions of temperature 25° C., pressure 2.0 ton/cm², and pressing period five hours.

[Evaluation] The filling rate of the power generation elements in the evaluation solid state batteries obtained in the first example and the first to third comparative examples was measured. Note that the filling rate measurement method described above was employed. Results are shown in FIG. 7. As shown in FIG. 7, it was confirmed that when hot pressing is performed, the filling rate improves in comparison with a case in which cold pressing is performed, regardless of the presence or absence of bridging sulfur. The reason for this is that during hot pressing, pressure molding is performed while the sulfide solid state electrolyte material is in a softened condition.

The interface resistance of the evaluation solid state batteries obtained in the first example and the first to third comparative examples was measured. First, the evaluation all solid state batteries were charged. In the charging operation, constant voltage charging was performed at 3.96 V for twelve hours. Following the charging operation, the interface resistance of the evaluation solid state batteries was determined through impedance measurement. The conditions of the impedance measurement were set such that a voltage amplitude was 10 mV, a measurement frequency was 1 MHz to 0.1 Hz, and the temperature was 25° C. Results are shown in FIG. 8.

As shown in FIG. 8, an interface resistance value of the second comparative example is far larger, i.e. approximately 1000 times larger, than that of the third comparative example. A possible reason for this is that during the heat treatment, the bridging sulfur in the sulfide solid state electrolyte material reacted with the positive electrode active material such that a high resistance layer was formed. Meanwhile, the interface resistance value of the first example is approximately 57% smaller than that of the first comparative example. A possible reason for this is that the reaction between the sulfide solid state electrolyte material and the positive electrode active material during the heat treatment was suppressed, and therefore formation of a high resistance layer was suppressed. Further, interface resistance is smaller in the first example than in the first comparative example. A possible reason for this is that the contact area between the positive electrode active material and the sulfide solid state electrolyte material was increased.

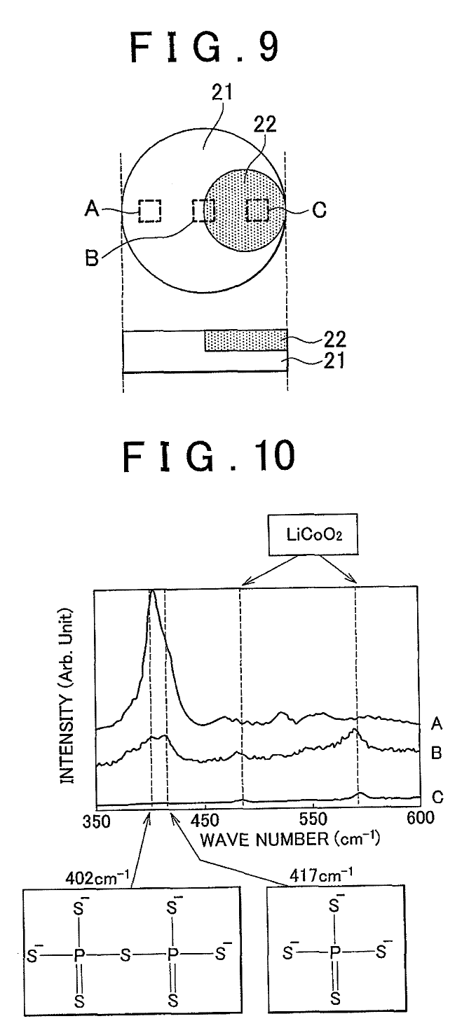

The condition of the interface between the positive electrode active material and the sulfide solid state electrolyte material containing bridging sulfur was observed using a Raman spectroscopy spectrum method. First, LiCoO₂ was prepared as the positive electrode active material and Li₇P₃S₁₁ was prepared as the sulfide solid state electrolyte material containing bridging sulfur. Note that Li₇P₃S₁₁ is crystallized sulfide glass obtained by crystallizing the 70 Li₂S-30 P₂S₅ used in the first comparative example through heat treatment. Next, as shown in FIG. 9, a two-phase pellet in which a positive electrode active material 22 is incorporated into a part of a sulfide solid state electrolyte material 21 containing bridging sulfur was created. The Raman spectroscopy spectrum was then measured in a region A, which is the region of the sulfide solid state electrolyte material 21, a region B, which is an interface region between the sulfide solid state electrolyte material 21 and the positive electrode active material 22, and a region C, which is the region of the positive electrode active material 22. Results are shown in FIG. 10.

In FIG. 10, a 402 cm⁻¹ peak is a peak of an S₃P—S—PS₃ structure, and a 417 cm⁻¹ peak is a peak of a PS₄ structure. In the region A, large peaks were detected at 402 cm⁻¹ and 417 cm⁻¹, whereas in the region B, both peaks were smaller and the reduction in the 402 cm⁻¹ peak (the S₃P—S—PS₃ structure peak) was particularly striking. It was therefore confirmed that the S₃P—S—PS₃ structure, which contributes greatly to lithium ion conduction, is broken down easily upon contact with the positive electrode active material.

An outline of an embodiment of the invention will be provided below.

An embodiment of the invention relates to an electrode active material layer including: an electrode active material; and a sulfide solid state electrolyte material which is fused to a surface of the electrode active material and is substantially free of bridging sulfur. According to this constitution, by employing a sulfide solid state electrolyte material that is substantially free of bridging sulfur, a high resistance layer generated by a reaction between the electrode active material and the sulfide solid state electrolyte material can be suppressed, and as a result, interface resistance on the electrode active material layer can be reduced.

The electrode active material layer may have a filling rate of at least 85%. According to this constitution, an improvement in energy density can be achieved. Furthermore, a contact area between particles of the sulfide solid state electrolyte material can be increased, and therefore an ion conduction path can be formed more easily.

In the electrode active material layer, the sulfide solid state electrolyte material may be a sulfide glass. According to this constitution, sulfide glass is softer than crystallized sulfide glass, and therefore expansion and contraction of the electrode active material can be absorbed, enabling an improvement in a cycle characteristic.

In the electrode active material layer, the sulfide solid state electrolyte material may be a crystallized sulfide glass. According to this constitution, an electrode active material layer having high Li ion conductivity can be obtained.

In the electrode active material layer, the sulfide solid state electrolyte material may contain Li₂S and one material selected from the group consisting of P₂S₅, SiS₂, GeS₂, and Al₂S₃. According to this constitution, an electrode active material layer that exhibits superior Li ion conductivity can be obtained.

In the electrode active material layer, the sulfide solid state electrolyte material may contain Li₂S and P₂S₅, and a ratio of a mole number of the P₂S₅ to a mole number of the Li₂S in the sulfide solid state electrolyte material may be no smaller than 11/39 and no larger than 14/36. According to this constitution, an electrode active material layer having reduced interface resistance can be obtained.

In the electrode active material layer, the electrode active material may be a positive electrode active material. According to this constitution, an increase in interface resistance due to generation of a high resistance layer can be suppressed effectively.

In an all solid state battery including a positive electrode active material layer, a negative electrode active material layer, and a solid state electrolyte layer formed between the positive electrode active material layer and the negative electrode active material layer, at least one of the positive electrode active material layer and the negative electrode active material layer may be the electrode active material layer described above. According to this constitution, the electrode active material layer described above is used as at least one of the positive electrode active material layer and the negative electrode active material layer, and therefore an all solid state battery having low interface resistance can be obtained.

Further, an embodiment of the invention relates to a method for manufacturing an electrode active material layer containing an electrode active material and a sulfide solid state electrolyte material which is fused to a surface of the electrode active material and is substantially free of bridging sulfur. The method may include: obtaining an electrode active material layer forming composite material by mixing together the electrode active material and the sulfide solid state electrolyte material; pressure-molding the electrode active material layer forming composite material; and performing a heat treatment on the electrode active material layer forming composite material to soften the sulfide solid state electrolyte material contained in the electrode active material layer forming composite material. According to this constitution, a sulfide solid state electrolyte material substantially free of bridging sulfur is used, and therefore, even though the pressure molding step and the heat treatment step are performed, a high-resistance layer generated by a reaction between the electrode active material and the sulfide solid state electrolyte material can be suppressed. As a result, an electrode active material layer having low interface resistance can be obtained.

In the method, the pressure molding and the heat treatment may be performed on the electrode active material layer forming composite material in parallel. According to this constitution, the electrode active material layer forming composite material is pressure-molded while the sulfide solid state electrolyte material is in a softened condition, and therefore an electrode active material layer having a high filling rate can be formed easily.

In the method, the heat treatment may include heating the electrode active material layer forming composite material at a temperature which is no lower than a temperature required for a glass transition of the sulfide solid state electrolyte material and lower than a temperature required for a crystallization of the sulfide solid state electrolyte material. According to this constitution, sulfide glass is obtained, and since sulfide glass is comparatively soft, expansion and contraction of the electrode active material can be absorbed. As a result, an electrode active material layer exhibiting a superior cycle characteristic can be obtained.

In the method, the heat treatment may include heating the electrode active material layer forming composite material at a temperature which is no lower than a temperature required for a crystallization of the sulfide solid state electrolyte material. According to this constitution, crystallized sulfide glass is obtained, and therefore an electrode active material layer having high ion conductivity can be obtained.

In the method, the sulfide solid state electrolyte material may contain Li₂S and one material selected from the group consisting of P₂S₅, SiS₂, GeS₂, and Al₂S₃. According to this constitution, an electrode active material layer that exhibits superior Li ion conductivity can be obtained.

In the method, the sulfide solid state electrolyte material may contain Li₂S and P₂S₅, and a ratio of a mole number of the P₂S₅ to a mole number of the Li₂S in the sulfide solid state electrolyte material may be no smaller than 11/39 and no larger than 14/36. According to this constitution, an electrode active material layer having reduced interface resistance can be obtained.

In the method, the electrode active material may be a positive electrode active material. According to this constitution, an increase in interface resistance due to generation of a high resistance layer can be suppressed effectively.

Further, an embodiment of the invention relates to a method for manufacturing an all solid state battery having an electrode active material layer that contains an electrode active material and a sulfide solid state electrolyte material which is fused to a surface of the electrode active material and is substantially free of bridging sulfur. The manufacturing method includes: obtaining an electrode active material layer forming composite material by mixing together the electrode active material and the sulfide solid state electrolyte material; preparing a processing composite material containing the electrode active material layer forming composite material; pressure-molding the processing composite material; and performing a heat treatment on the processing composite material to soften the sulfide solid state electrolyte material contained in the electrode active material layer forming composite material. According to this constitution, a processing composite material that includes a sulfide solid state electrolyte material substantially free of bridging sulfur is used, and therefore, even though the pressure molding step and the heat treatment step are performed, a high-resistance layer generated by a reaction between the electrode active material and the sulfide solid state electrolyte material can be suppressed. As a result, an all solid state battery having low interface resistance can be obtained.

While some embodiments of the invention have been illustrated above, it is to be understood that the invention is not limited to details of the illustrated embodiments, but may be embodied with various changes, modifications or improvements, which may occur to those skilled in the art, without departing from the scope of the invention.

What is claimed is:

1. An electrode active material layer comprising:
an electrode active material; and
a sulfide solid state electrolyte material which is fused to a surface of the electrode active material and is substantially free of a bridging sulfur.

2. The electrode active material layer according to claim 1, has a filling rate of at least 85%.

3. The electrode active material layer according to claim 1, wherein the sulfide solid state electrolyte material is a sulfide glass.

4. The electrode active material layer according to claim 1, wherein the sulfide solid state electrolyte material is a crystallized sulfide glass.

5. The electrode active material layer according to claim 1, wherein the sulfide solid state electrolyte material contains Li₂S and one material selected from the group consisting of P₂S₅, SiS₂, GeS₂, and Al₂S₃.

6. The electrode active material layer according to claim 5, wherein the sulfide solid state electrolyte material contains Li₂S and P₂S₅, and
a ratio of a mole number of the P₂S₅ to a mole number of the Li₂S in the sulfide solid state electrolyte material is no smaller than 11/39 and no larger than 14/36.

7. The electrode active material layer according to claim 1, wherein the electrode active material is a positive electrode active material.

8. An all solid state battery comprising:
a positive electrode active material layer;
a negative electrode active material layer; and
a solid state electrolyte layer formed between the positive electrode active material layer and the negative electrode active material layer,
wherein at least one of the positive electrode active material layer and the negative electrode active material layer is the electrode active material layer according to claim 1.

9. A method for manufacturing an electrode active material layer containing an electrode active material and a sulfide solid state electrolyte material which is fused to a surface of the electrode active material and is substantially free of a bridging sulfur, comprising:
obtaining an electrode active material layer forming composite material by mixing together the electrode active material and the sulfide solid state electrolyte material;
pressure-molding the electrode active material layer forming composite material; and
performing a heat treatment on the electrode active material layer forming composite material to soften the sulfide solid state electrolyte material contained in the electrode active material layer forming composite material.

10. The method according to claim 9, wherein the pressure molding and the heat treatment are performed on the electrode active material layer forming composite material in parallel.

11. The method according to claim 9, wherein the heat treatment includes heating the electrode active material layer forming composite material at a temperature which is no lower than a temperature required for a glass transition of the sulfide solid state electrolyte material and lower than a temperature required for crystallization of the sulfide solid state electrolyte material.

12. The method according to claim 9, wherein the heat treatment includes heating the electrode active material layer forming composite material at a temperature which is no lower than a temperature required for a crystallization of the sulfide solid state electrolyte material.

13. The method according to claim 9, wherein the sulfide solid state electrolyte material contains Li₂S and one material selected from the group consisting of P₂S₅, SiS₂, GeS₂, and Al₂S₃.

14. The method according to claim 9, wherein the sulfide solid state electrolyte material contains Li₂S and P₂S₅, and
a ratio of a mole number of the P₂S₅ to a mole number of the Li₂S in the sulfide solid state electrolyte material is no smaller than 11/39 and no larger than 14/36.

15. The method according to claim 9, wherein the electrode active material is a positive electrode active material.

16. A method for manufacturing an all solid state battery having an electrode active material layer that contains an electrode active material and a sulfide solid state electrolyte material which is fused to a surface of the electrode active material and is substantially free of a bridging sulfur, comprising:
obtaining an electrode active material layer forming composite material by mixing together the electrode active material and the sulfide solid state electrolyte material;
preparing a processing composite material containing the electrode active material layer forming composite material;
pressure-molding the processing composite material; and
performing a heat treatment on the processing composite material to soften the sulfide solid state electrolyte material contained in the electrode active material layer forming composite material.
